(19) United States
(12) Patent Application Publication
(10) Pub. No.: US 2002/0019850 A1
(43) Pub. Date: Feb. 14, 2002

(54) Electronic mail service system

(75) Inventor: Noriyasu Nakamura, Shizuoka (JP)

Correspondence Address: David A. Blumenthal, FOLEY & LARDNER, Washington Harbour, 3000 K Street, N.W., Suite 500, Washington, DC, 20007-5109, US

(73) Assignee: NEC CORPORATION

(21) Appl. No.: 09/907,650

(22) Filed: Jul. 19, 2001

(30) Foreign Application Priority Data
Aug. 3, 2000 (JP) 2000-235762

(51) Int. Cl. G06F 15/16

(52) U.S. Cl. 709/206

(57) ABSTRACT

When an electronic mail service center (40) receives a request for direct mail transmission from a company user terminal (10), it searches personal information stored in a database for general users satisfying a condition on a destination and automatically transmits a direct mail to general user terminals (20) of the users satisfying the condition. When the direct mail is in the form of a questionnaire, the electronic mail service center (40) receives the replies to the questionnaire from the general user terminals (20), compiles the replies, and transmits the compiled replies to the company user terminal (10). When the electronic mail service center (40) receives an electronic mail addressed to a registered user after the registered user establishes a condition of electronic mail reception, the electronic mail service center (40) transmits the electronic mail to a registered user terminal (30) if the received electronic mail satisfies the condition of electronic mail reception of the registered user, or withholds transmission of the electronic mail addressed to the registered user if it does not satisfy the condition of electronic mail reception. In this manner, a reduction in time from creation of a direct mail to transmission thereof is achieved as well as a reduction in cost, thereby reducing a communication fee.

### BACKGROUND OF THE INVENTION

1. Field of the Invention

The present invention relates to an electronic mail service system for providing direct mail transmission service through the use of electronic mail and for providing service to limit reception of electronic mail.

2. Description of the Related Art

Conventionally, direct mail is delivered by mail or home delivery. Conventional direct mail transmission systems involve tasks such as extracting target consumers from a database, writing addresses, and enclosing a questionnaire in each direct mail.

When a conventional electronic mail service system is used to subscribe to a mail magazine or the like, a subscriber may receive an enormous amount and a wide variety of electronic mail in a day or receive mischievous mail.

The delivery of conventional direct mail requires much time and effort for enclosing letters in envelopes, writing addresses and the like. Even after a resident moves out from an apartment house, mail addressed to the resident may continue to be delivered to the apartment house. In such a case, the actual situation in the destination does not correspond to data contents on the destination managed in a database which results in wasted transmission sometimes.

In addition, when an enormous amount and a wide variety of electronic mail is received, the conventional electronic mail service system for a mail magazine or the like requires a reader to check subjects or bodies of the mail one by one to extract essentially necessary electronic mail therefrom. Furthermore, a PDC digital cellular phone with electronic mail functions nowadays days is inundated with mischievous mail. Consequently, a needless communication fee is involved in receiving the mischievous mail and essentially unnecessary mail other than the necessary mail described above.

### SUMMARY OF THE INVENTION

It is an object of the present invention to provide an electronic mail service system which can solve the aforementioned problems and can achieve a reduction in cost and time from creation of a direct mail to transmission thereof to reduce a communication fee.

The electronic mail service system of the present invention comprises a company user terminal for establishing a condition on a destination of an electronic mail to make a request for direct mail transmission through the electronic mail, and an electronic mail service center for searching, upon receipt of the request for direct mail transmission through the electronic mail from the company user terminal over a communication network, personal information stored in a database for general users satisfying the destination condition and automatically transmitting a direct mail through an electronic mail to terminals of the general users satisfying the condition.

When the direct mail is in the form of a questionnaire, the electronic mail service center may receive the replies to the questionnaire from the terminals of the general users over the communication network, compile the replies, and transmit the compiled replies to the company user terminal.

The electronic mail service system may further comprise a registered user terminal for allowing a user registered with the electronic mail service center to establish a condition of electronic mail reception to the electronic mail service center through an electronic mail over the communication network, wherein, when the electronic mail service center receives an electronic mail addressed to the registered user from a general user after the condition of electronic mail reception is established, the electronic mail service center may transmit the electronic mail to the registered user terminal if the received electronic mail satisfies the condition of electronic mail reception of the registered user, or withhold transmission of the electronic mail addressed to the registered user if it does not satisfy the condition of electronic mail reception.

The above and other objects, features, and advantages of the present invention will become apparent from the following description based on the accompanying drawings which illustrate an example of preferred embodiments of the present invention.

### BRIEF DESCRIPTION OF THE DRAWINGS

FIG. 1 is a block diagram illustrating a first embodiment of an electronic mail service system of the present invention;

FIG. 2 is a block diagram for explaining the electronic mail service center;

FIG. 3 is a flow chart for operations when a direct mail requester such as a company transmits direct mail with the electronic mail service center;

FIG. 4 is a table schematically showing contents stored in a database; and

FIG. 5 is a flow chart for explaining operations of receiving an electronic mail when a registered user of the electronic mail service system establishes a condition of reception.

### DETAILED DESCRIPTION OF THE PREFERRED EMBODIMENTS

Next, preferred embodiments of the present invention are described with reference to the drawings.

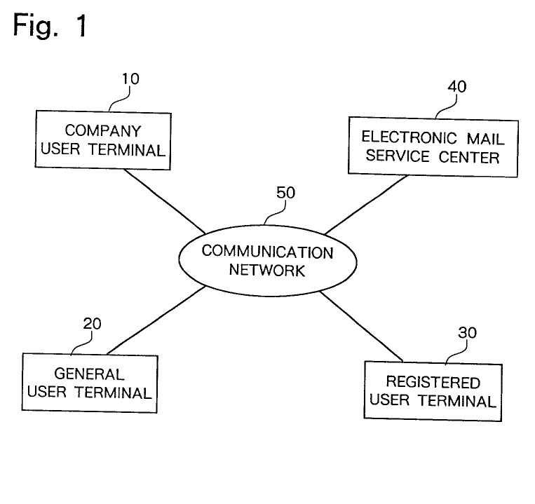

FIG. 1 is a block diagram illustrating a first embodiment of an electronic mail service system of the present invention. The electronic mail service system shown in FIG. 1 comprises company user terminal 10, general user terminal 20, registered user terminal 30, electronic mail service center 40, and communication network 50 such as the Internet for interconnecting them.

Company user terminal 10, general user terminal 20, and registered user terminal 30 are information processing devices such as personal computers, PDC digital cellular phones with electronic mail functions, or PDAs (Personal Digital Assistants). Company user terminal 10, general user terminal 20, and registered user terminal 30 have the functions of accessing one another through electronic mail over communication network 50.

Company user terminal 10 is registered with electronic mail service center 40 and has the function of making a request for direct mail transmission to electronic mail service center 40. Registered user terminal 30 is registered with electronic mail service center 40 and has the function of establishing a condition of direct mail reception to electronic mail service center 40.

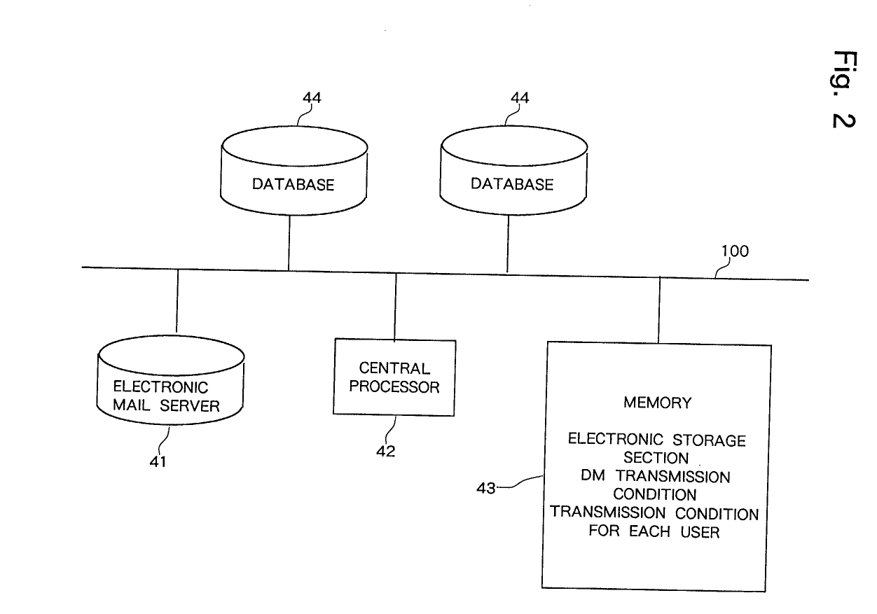

FIG. 2 is a block diagram for explaining electronic mail service center 40. Electronic mail service center 40 shown in FIG. 2 comprises electronic mailer server 41, central processor 42, memory 43, databases 44, and bus 100 interconnecting them.

Electronic mail server 41 has the function of transmitting and receiving electronic mail over communication network 50. Central processor 42 has the function of recognizing a condition of electronic mail transmission or reception, the function of performing a search in accordance with the condition of electronic mail transmission or reception to transmit an electronic mail, and the function of performing compilation. Memory 43 has the function of storing and saving a condition of electronic mail or direct mail transmission and a condition of reception for each user. Database 44 has personal information stored therein such as electronic mail addresses, names, ages and the like.

Next, description is made for the operation of the electronic mail service system shown in FIG. 1. Firstly, the electronic mail service system shown in FIG. 1 provides direct mail transmission service through the use of electronic mail.

A company or the like registers itself as a user with electronic mail service center 40 in advance. A direct mail requester such as a company uses company user terminal 10 to make a request for direct mail transmission to electronic mail service center 40 over communication network 50. The request for transmission is transmitted to the electronic mail address of a terminal of electronic mail service center 40 through the use of an electronic mail. A condition on a destination (such as age, sex, or occupation) is described in the request for transmission.

Upon receipt of the request for direct mail transmission, electronic mail service center 40 searches the personal information stored in database 44 for consumers matching the transmission condition and automatically transmits direct mail to terminals (general user terminals 20) of the consumers through electronic mail.

When the direct mail is in the form of a questionnaire, replies to the questionnaire are transmitted to electronic mail service center 40 from general user terminals 20 through communication network 50. In response to the replies to the questionnaire, electronic mail service center 40 performs compilation and transmits the compiled result to company user terminal 10.

Secondly, the electronic mail service system shown in FIG. 1 provides service to limit reception of electronic mail.

An electronic mail addressed to a user registered with electronic mail service center 40 is transmitted to the registered user through the server of electronic mail service center 40. The registered user uses registered user terminal 30 to establish a reception condition in electronic mail service center 40 through communication network 50. The establishment of the reception condition is transmitted to the electronic mail address of the terminal of electronic mail service center 40 through the use of electronic mail. A reception condition (such as transmitter and the presence or absence of a specified word or phrase) is described in the established reception condition.

When electronic mail service center 40 receives an electronic mail addressed to a registered user from a general user after the receipt of the established reception condition, electronic mail service center 40 transmits the electronic mail to the registered user if the electronic mail satisfies the reception condition, or withholds its transmission and stores it in the server if it does not satisfy the reception condition. For example, when a registered user establishes a condition of electronic mail reception of “the words “cellular phone” included in the body of an electronic mail,” then electronic mail service center 40 selects electronic mail including the words “cellular phone” in their bodies, for example, “information on new cellular phone . . . ” or “. . . a comparative report on cellular phones for each manufacturer,” from received electronic mail addressed to the registered user, and transmits only the selected mail to the registered user.

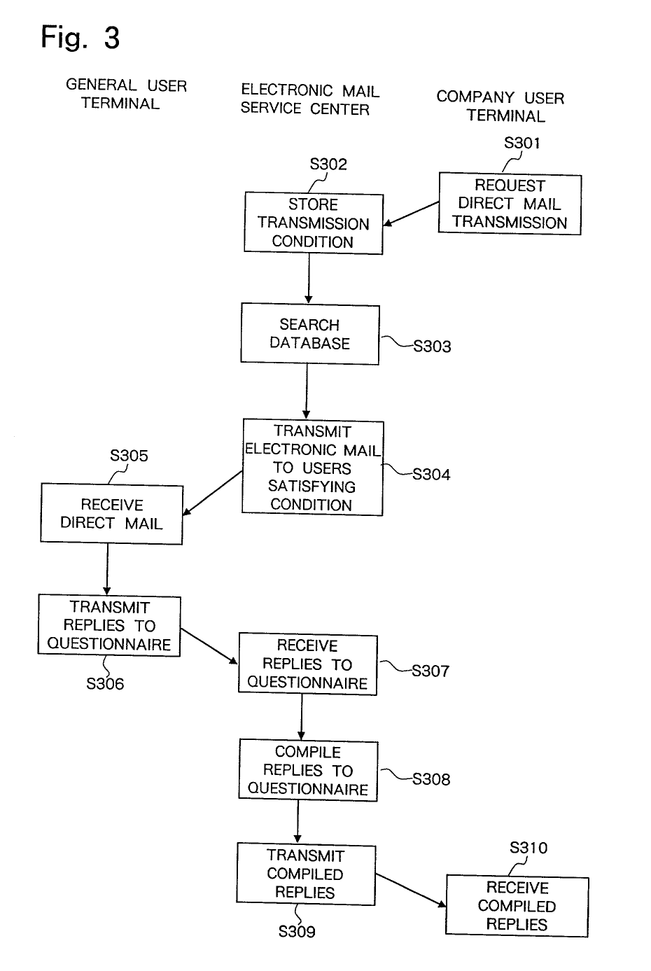

Next, the direct mail transmission service through the user of electronic mail is described in detail with reference to FIG. 3. In the following description, communication network 50 is assumed to be the Internet.

FIG. 3 is a flow chart for operations when a direct mail requester such as a company transmits direct mail using electronic mail service center 40.

In the first place, the direct mail requester transmits an electronic mail to the electronic mail address dedicated to electronic mail service center 40 from company user terminal 10 to make a request for transmission (step 301). The transmitted electronic mail includes a condition of direct mail transmission and a condition of compilation of replies to a questionnaire such as the closing date and the number of replies as a text file and contents of direct mail such as a questionnaire as an attached file.

Next, upon receipt of the electronic mail from the direct mail requester, electronic mail service center 40 recognizes and stores the condition of direct mail transmission (step 302). Electronic mail service center 40 searches the personal information in database 44 for general users satisfying the condition of transmission (step 303), and transmits direct mail as electronic mail to general user terminals 20 of the users based on the search result (step 304).

Next, each user satisfying the transmission condition receives the direct mail transmitted from electronic mail service center 40 at general user terminal 20 (step 305), and the general user receiving the mail replies to the questionnaire in the direct mail and returns it to electronic mail service center 40 (step 306).

Next, electronic mail service center 40 receives the reply to the questionnaire from the general user (step 307). When the condition of compilation (such as the specified closing date or the specified number of replies) specified by the direct mail requester is satisfied, electronic mail service center 40 compiles the replies to the questionnaire and summarizes the compiled result (step 308). Electronic mail service center 40 then transmits the compiled result to company user terminal 10 (step 309).

Company user terminal 10 receives the compiled result transmitted from electronic mail service center 40 (step 310).

Next, description is hereinafter made for a method of recognizing, by electronic mail service center 40, the condition of direct mail transmission and the condition of compilation specified by the direct mail requester.

The transmission condition is a condition for extracting general users to which direct mail is to be transmitted from all general users in database 44, for example, an age or age bracket, sex, occupation, residence or the like.

The compilation condition is a condition such as a compilation method or closing date when a questionnaire survey is performed through direct mail, for example, a reply receivable date indicating replies receivable from when to when or replies receivable until when, the number of replies at which compilation is started, or a compilation method such as the compilation result presented in graphical form or in separate database form.

The aforementioned conditions are recognized by central processor 42 of electronic mail service center 40. Central processor 42 reads the text file transmitted by company user terminal 10 and searches for a character string. The character string searched for is, for example, characters of “age:” “sex:” “closing date:” or the like. If such characters are found in the text file, the description after “:” is recognized as the transmission condition or compilation condition.

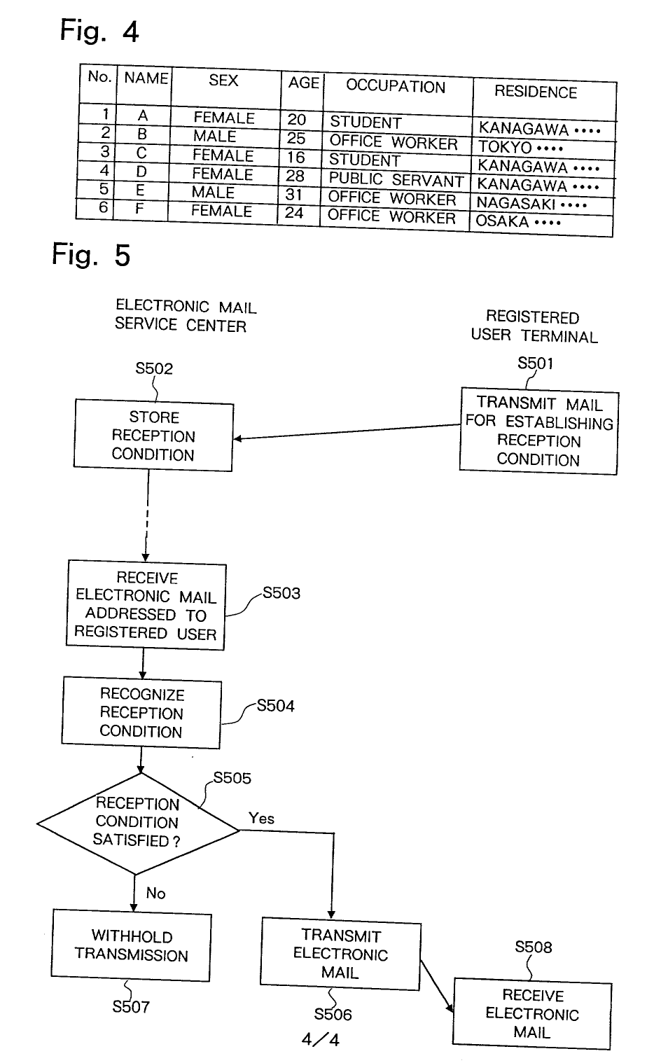

By way of example, assume that database 44 has the contents shown in FIG. 4 stored therein and company user terminal 10 transmits the direct mail transmission request in the text file as follows:

I make a request for direct mail transmission under the following conditions.

(transmission conditions)

age :18 to 30

sex :female

residence :Kanagawa

In this case, direct mail is transmitted to general user terminals 20 of Name A of No. 1 and Name D of No. 4 shown in FIG. 4.

Next, description is made for a compilation method when a questionnaire survey is performed through direct mail.

An attached file for questionnaire is in textual form in which a question section has question entries each assigned serial numbers starting from 1. In a reply section, each selective question entry, such as an entry prompting selection of Yes or No, has serial numbers starting from (1) each assigned to selective replies, or each free writing question entry has brackets [ ] in its reply space such that a reply is written into the brackets [ ].

The reply descriptions are recognized by central processor 42. Central processor 42 reads the text file transmitted by general user terminal 20 and searches for a character string.

For the selective question entries, central processor 42 recognizes the replies for each question entry by using “1,” “2,” “3,”. . . , corresponding to each question entry and “(1),” “(2),” “(3),”. . . , corresponding to each selective reply of the general user as the character string searched for.

For the free writing question entries, central processor 42 recognizes the character string surrounded by “[” and “]” as the written reply by using “1,” “2,”“3,” . . . , corresponding to each question entry and “[” and “]” corresponding to each written reply of the general user as the character string searched for.

The compilation of the replies is performed for each question entry. The compiled data is presented as percentages in circle graphs for the questions prompting selection from two options (Yes or No) to five options, or presented as the numbers of the replies in bar charts for the questions prompting selection from six or more options. Comments are enumerated for each question entry. It is also possible to organize the compilation result for each age bracket, each occupation and the like from all the repliers based on the electronic mail addresses. When the compilation condition specifies provision of separate databases, the replies are compiled and stored in databases for each general user.

For example, when the questionnaire and reply thereto are as follows:

(questionnaire)

1. Are you insured?

(1) Yes

(2) No

2. Are you satisfied with the details on the insurance?

(1) Very satisfied

(2) Satisfied

(3) Not so satisfied

(4) Unsatisfied

3. Is there any insurance or special contract you are interested in?

[ ]

(reply to questionnaire)

1. Are you insured?

(1) Yes

2. Are you satisfied with the details on the insurance?

(2) Satisfied

3. Is there any insurance or insurance special contract you are interested in?

[adult diseases special contract, three major diseases special contract]

then, central processor 42 recognizes (1) as the reply to question entry 1, (2) as the reply to question entry 2, and “adult diseases, three major diseases special contract” as the reply to question entry 3.

If no questionnaire is required, processing only from step 301 to step 304 is performed.

After the direct mail is transmitted, electronic mail service center 40 receives a notification of an undelivered electronic mail with a nonexistent electronic mail address. In this case, central processor 42 recognizes the address of the electronic mail which has not arrived from the header of the mail and deletes the personal information associated with the address from database 44.

Next, the service to limit reception of mail is described in detail with reference to FIG. 5. FIG. 5 is a flow chart for explaining operations of receiving an electronic mail when a user registered with the electronic mail service system establishes a condition of reception.

The user registered with electronic mail service center 40 first transmits the reception condition in a text file to the electronic mail address dedicated to electronic mail service center 40 from registered user terminal 30 (step 501).

Electronic mail service center 40 receives the electronic mail from the registered user and stores the reception condition (step 502).

When electronic mail service center 40 receives an electronic mail addressed to the registered user (step 503), it checks the stored reception condition for the registered user (step 504) and compares the received mail addressed to the registered user with the reception condition for the registered user (step 505).

If the received mail addressed to the registered user satisfies the reception condition, electronic mail service center 40 transmits the electronic mail to the registered user (step 506). If the electronic mail does not satisfy the reception condition, electronic mail service center 40 withholds its transmission and stores it in memory 43 (step 507).

The registered user receives the electronic mail addressed to himself satisfying the reception condition transmitted from electronic mail service center 40 at registered user terminal 40 (step 508).

The withheld mail can be received by collective reading.

Next, description is hereinafter made for a method of recognizing the reception condition for the registered user by the electronic mail service center.

The reception condition is a condition such as a transmitter or transmitted contents of an electronic mail addressed to the registered user when he receives it. For example, the condition includes the electronic mail address of a transmitter limited to have “tok.kyo.co.jp” after @, or the body of an electronic mail to include or not to include a word or phrase specified by a user.

The reception condition is recognized by central processor 42 of electronic mail service center 40. Central processor 42 searches the text file transmitted by registered user terminal 30 for characters such as “transmitter:” “including—in a body” or the like, and recognizes the description after “:” for “transmitter:” as the reception condition or recognizes the description between “including” and “in a body” as the reception condition.”

Next, description is hereinafter made for a method of comparing the received mail with the reception condition at step 505.

The comparison of the received mail with the reception condition is performed by central processor 42 of electronic mail service center 40. When a condition on a transmitter is specified, central processor 42 identifies a transmitter from the header of an electronic mail transmitted from general user terminal 20 to make a comparison with the condition. When a specified condition is inclusion/no inclusion of a specified word or phrase in the subject and body, central processor 42 searches the subject and body of an electronic mail transmitted from general user terminal 20 for the user specified word or phrase to determine whether the word or phrase is present or not, thereby making a comparison with the condition.

Next, a second embodiment of the present invention is described.

In the first embodiment, the body of a direct mail such as a questionnaire is transmitted as an attached file in an electronic mail. In the second embodiment, however, the body of a direct mail is not transmitted as an attached file but inserted into the body of a mail together with a transmission condition or compilation condition of the direct mail.

A direct mail requester enters a separating mark specified by electronic mail service center 40 in a section between the transmission condition or compilation condition of the direct mail and the body of the direct mail to create and transmit a document for requesting direct mail transmission. For example, when “DMDMDMDMDMDMDMDMDMDMDMDMDMDMDMDMDMDMDMDM” is used as the separating mark, the document for requesting direct mail transmission is created as follows:

I request transmission of a direct mail under the following conditions.

(transmission conditions)

age :18 to 30

sex :female

residence :Kanagawa

The following is the body of the direct mail. DMDMDMDMDMDMDMDMDMDMDMDMDMDMDMDMDMDMDMDM

(questionnaire)

1. Are you insured?

(1) Yes

(2) No

2. Are you satisfied with the contents of the insurance?

(1) Very satisfied

(2) Satisfied

(3) Not so satisfied

(4) Unsatisfied

3. Is there any insurance or special contract you are interested in?

[ ]

The discrimination between the transmission condition or compilation condition of the direct mail and the body thereof is made by central processor 42. Central processor 2 reads the text file transmitted by company user terminal 10 to search for a character string. The character string searched for is the separating mark (in the aforementioned example, “DMDMDMDMDMDMDMDMDMDMDMDMDMDMDMDMDMDMDMDM”). Central processor 42 recognizes the portion of the mail before the character string searched for as the transmission condition or compilation condition of the direct mail and recognizes the portion of the mail after the separating mark as the body of the direct mail. The second embodiment is similar to the first embodiment in the recognition of the details on the transmission condition or compilation condition of the direct mail, the recognition of the details on the questionnaire and replies thereto and the like.

Next, a third embodiment of the present invention is described.

The third embodiment differs from the first and second embodiments in that the specified transmission condition or compilation condition of the direct mail, the body of and replies to the questionnaire and the like in the form of a text file are replaced with ones in the form of a commercially available application file other than the text file or an application file unique to electronic mail service center 40.

The transmission condition, compilation condition of the direct mail or the like created in the aforementioned application file form is transmitted from company user terminal 10 as an attached file of an electronic mail. Electronic mail service center 40 identifies the application used by the company user with the extension of the file to open the file using the associated application.

A character string search function of the application is used to recognize the details on the transmission condition, compilation condition of the direct mail or the like similarly to the first embodiment. Alternatively, the aforementioned file is converted into a test file and then a character string search is performed in the file similarly to the first embodiment to recognize the details on the transmission condition, compilation condition of the direct mail or the like.

As described above, in the present invention, the electronic mail service center automatically transmits the direct mail to the general user terminals in response to the request for direct mail transmission, thereby enabling a reduction in time from creation of the direct mail to the transmission thereof and reduced costs due to a reduction in man-hours required for enclosing letters in envelopes and writing addresses in the direct mail. A reduction in the number of undelivered direct mail can also cut down the cost.

In addition, the present invention can reduce time from the collection of the replies to the questionnaire to the compilation thereof since the electronic mail service center receives the replies to perform compilation. The limitation on received electronic mail can reduce the communication fee. Furthermore, the limitation on transmitters can prevent reception of mischievous mail or the like.

It is to be understood, however, that although characteristics and advantages of the present invention have been set forth in the foregoing description, the disclosure is illustrative only, and changes may be made in the arrangement of the parts within the scope of the appended claims.

What is claimed is:

1. An electronic mail service system comprising:
a communication network;
an electronic mail service center including an electronic mail server connecting to said communication network;
a plurality of company user terminals each including an information processing unit connecting to said communication network;
a plurality of general user terminals each including an information processing unit connecting to said communication network,
each said company user terminal establishing a condition on a destination of an electronic mail and making a request for direct mail transmission to said electronic mail service center through said electronic mail; and
said electronic mail service center searching, upon receipt of said request for direct mail transmission through said electronic mail from said company user terminal over said communication network, personal information stored in a database for general users satisfying said destination condition and automatically transmitting a direct mail through electronic mail to terminals of said general users satisfying said condition.

2. The electronic mail service system according to claim 1, further comprising a registered user terminal for enabling a user to establish a condition of electronic mail reception to said electronic mail service center through an electronic mail over said communication network,
wherein said electronic mail service center transmits a received electronic mail addressed to said user of said registered user terminal to said registered user terminal if said electronic mail satisfies said established reception condition, or withholds transmission of said electronic mail if said electronic mail does not satisfy said reception condition.

3. The electronic mail service system according to claim 1, wherein, when said direct mail is in the form of a questionnaire, said electronic mail service center receives replies to said questionnaire from said terminals of said general users over said communication network, compiles said replies to said questionnaire, and transmits said compiled replies to said company user terminal.

4. The electronic mail service system according to claim 3, wherein the name of a user is registered with said electronic mail service center, said electronic mail service system further comprising a registered user terminal for enabling said registered user to establish a condition of electronic mail reception to said electronic mail service center through an electronic mail over said communication network,
wherein, when said electronic mail service center receives an electronic mail addressed to said registered user from a general user after said condition of electronic mail reception is established, said electronic mail service center transmits said electronic mail to said registered user terminal if said received electronic mail satisfies said condition of electronic mail reception established by said user, or withholds transmission of said electronic mail addressed to said registered user if said electronic mail does not satisfy said condition of electronic mail reception.

5. An electronic mail service system comprising:
a communication network;
an electronic mail service center including an electronic mail server connecting to said communication network;
a plurality of registered user terminals each including an information processing unit connecting to said communication network;
a plurality of general user terminals each including an information processing unit connecting to said communication network,
said registered user terminal enabling a user to register himself with said electronic mail service center through an electronic mail over said communication network and to establish a condition of electronic mail reception;
when said electronic mail service center receives an electronic mail addressed to said user from a general user after said condition of electronic mail reception is established on said registered user terminal, said electronic mail service center transmitting said received electronic mail to said registered user terminal if said electronic mail satisfies said condition of electronic mail reception established by said user, or withholding transmission of said electronic mail addressed to said user if said electronic mail does not satisfy said condition of electronic mail reception.

6. A method of electronic mail service, comprising the steps of:
receiving, by an electronic mail service center, a request for direct mail transmission from a company user terminal over a communication network;
searching, by said electronic mail service center, personal information stored in a database for general users satisfying a condition of a destination,
automatically transmitting, by said electronic mail service center, a direct mail through electronic mail to terminals of said users satisfying said condition;
when said direct mail is in the form of a questionnaire, receiving, by said electronic mail service center, replies to said questionnaire from said terminals of said users over said communication network;
compiling, by said electronic mail service center, said replies to said questionnaire and transmitting said compiled replies to said company user terminal.

7. A method of electronic mail service, comprising the steps of:
receiving, by an electronic mail service center, an electronic mail addressed to a user from a terminal of a general user after said user establishes a condition of electronic mail reception;
transmitting, by said electronic mail service center, said received electronic mail to a terminal of said user if said electronic mail satisfies said condition of electronic mail reception established by said user, or withholding transmission of said electronic mail addressed to said user if said electronic mail does not satisfy said condition of electronic mail reception.
